(19) United States
(12) Patent Application Publication
(10) Pub. No.: US 2015/0132099 A1
(43) Pub. Date: May 14, 2015

(54) METHOD AND DEVICE FOR LIFTING AN OBJECT FROM THE SEA FLOOR

(71) Applicant: Fraunhofer-Gesellschaft zur Foerderung der angewandten Forschung e.V., Muenchen (DE)

(72) Inventors: Guenter R. Fuhr, Berlin (DE); Heiko Zimmermann, Waldbrunn (DE)

(21) Appl. No.: 14/400,746

(22) PCT Filed: Jun. 3, 2013
(86) PCT No.: PCT/EP2013/001618

§ 371 Date: Nov. 12, 2014

(30) Foreign Application Priority Data
Jun. 6, 2012 (DE) 10 2012 011 327.7

(51) Int. Cl. B66F 19/00; B63C 7/10; E21C 50/00

(52) U.S. Cl. CPC B66F 19/00; E21C 50/00; B63C 7/10
USPC 414/803; 414/800; 114/54

(57) ABSTRACT

The invention relates to a method for lifting an object (1) from the sea floor, comprising the steps: coupling of the object (1) to a buoyancy balloon (10), and a buoyant motion of said buoyancy balloon (10) with the object (1), the buoyancy balloon (10) being filled with a buoyancy liquid such as, for example, water, the temperature of which is higher than the temperature of the sea water surrounding said buoyancy balloon (10). The invention also relates to a balloon device (100) which is configured for lifting an object (1) from the sea floor.

The invention concerns a method for raising at least one object from the seabed, in particular for the transportation of mineral raw materials, such as, for example, manganese nodules or other bodies containing metal, or other loads, such as e.g. wreckage, from the seabed to the sea surface. Furthermore the invention concerns a device for raising at least one object from the seabed. Applications of the invention are provided e.g. by the underwater mining of natural resources, or by the recovery of objects from the seabed.

In deep sea (at a depth of more than 1,000 m, in particular more than 2,000 m) mineral raw materials are located on the seabed as natural resources in the form of loose rocks (e.g. manganese nodules, phosphorite, mineral ores). It is for example known that in deep sea, dissolved substances are precipitated in the form of metal conglomerates, owing to the pressure and temperature conditions found there. For example, metallic nodules are formed, or metallic surface coatings of metals or metal compounds, such as e.g. manganese, cobalt, and other materials, are formed on minerals. Seabeds that are populated in this manner by precipitated metals or metal compounds, for example in the Pacific, form ore deposits of great economic significance.

The industrial recovery of mineral raw materials from deep sea represents a technical challenge that up to the present time has only been unsatisfactorily solved. Attempts to suck up the seabed at depths of 2000 m to 7000 m using suction equipment, and in this manner to recover e.g. metal conglomerates are not in accord with protection of the deep sea habitat and the mass of water located above it. In DE 32 25 728 A1 the mining of manganese nodules with a so-called cryo-gripper is proposed, but in practice this is only suitable to a limited extent for use in deep sea, and does not enable the raising of manganese nodules to the sea surface.

In practice the aim is to fulfill the following conditions when exploiting undersea raw material deposits: (1) selective and direct recovery of the raw materials without a destruction of the biological fauna, and (2) zero-residue transport to the surface without significant impairment of water stratifications and flow conditions (i.e. materials transported to the surface during the recovery operation may not be fed back into the surface water and may not sediment through the various depth intervals onto the seabed and/or be distributed in flowing water). By virtue of (1) suction of the seabed is ruled out, while (2) signifies that the only material that is to be recovered is that which is transported away, i.e. in the most favorable case just the metal conglomerates.

Although robotic systems have been proposed, which could collect metallic nodules individually or in groups on the seabed, up to the present time no practical technology exists for the transportation of metallic nodules with a total weight of the order of tons over a distance of 2,000 m to 7,000 m to the sea surface, and from there onto ships. Up to the present time no form of environmentally friendly and energy-efficient transportation of the collected raw materials to the surface with minimal damage has been available. Solution of the problem is made more difficult in that deep sea regions in the open ocean are located far from the continental shelf, and thus recovery technology should not be installed at a fixed location, but instead should be mobile.

One particular problem in the recovery of large loads from deep sea consists in the fact that a lifting force can only be achieved with difficulty. The hydrostatic pressure increases by 1 bar for every 10 m. At a depth of 4,000 m a pressure of approx. 400 bar=40 MPa therefore prevails. At this pressure gas-filled systems cannot be used to provide the lifting force, as is common in shallow water regions in the recovery of wreckage, since the gas volume is highly compressed and delivers hardly any lifting force.

In a lifting technology for deep-sea diving equipment glass sphere foams (so-called syntactic foams, e.g. EL 34, manufactured by Trelleborg), consisting of air-filled, pressure-resistant glass spheres, which are embedded in a pressure-resistant composite medium, are used. However, these foams only achieve a relative buoyancy of the order of 10 to 20%. In deep-sea diving equipment, moreover, lifting bodies in the form of non-pressure-resistant containers that are filled, for example, with benzene, are of known art. Here too, however, only a small buoyancy is generated, which would be insufficient for the recovery of raw materials. Furthermore it can be disadvantageous that when in use the containers are lowered into deep sea using an active drive or the action of a load. Finally large manually controlled diving vehicles that are designed for depths of several kilometers and equipped with a pressure-resistant hull are also unsuitable for the recovery of raw materials on cost grounds.

The objectives of the invention are to provide an improved method and an improved device for raising at least one object from the seabed, in particular for purposes of transporting mineral raw materials or other loads from the seabed to the sea surface, with which the disadvantages of conventional technologies are avoided. The invention should in particular enable items of large mass, such as e.g. raw materials, to be transported from the seabed in the direction of the surface in an environmentally friendly and/or energy-efficient manner with minimal damage.

These objectives are achieved by means of a method and a device with the features of the independent claims. Advantageous embodiments and applications of the invention ensue from the dependent claims.

In accordance with a first aspect the invention is based on the general technical teaching of providing a method for raising at least one object from the seabed, in which the at least one object is connected to a buoyancy balloon and an uplift movement of the buoyancy balloon is executed, together with the object. In accordance with the invention provision is made for the buoyancy balloon to be filled with a buoyancy fluid. In accordance with the invention provision is furthermore made for the temperature of the buoyancy fluid in the buoyancy balloon to be higher than the temperature of the seawater that surrounds the buoyancy balloon. The buoyancy fluid is in general a fluid with a density that is less than, or the same as, the density of water, in particular of seawater. The mass density of the buoyancy fluid is e.g. less than 1,100 kg/m³, in particular less than 1,050 kg/m³ (e.g. less than 1,000 kg/m³). The buoyancy fluid comprises, e.g. water, or a fluid hydrocarbon compound. At the elevated temperature the mass density of the buoyancy fluid in the buoyancy balloon relative to the mass density of the surrounding seawater is significantly reduced, so that in comparison to conventional technologies a higher lifting force is generated. With the invention it is possible to raise large masses of the order of tons, in particular of up to 1 ton or more, e.g. 5 tons or 10 tons or more, from the seabed. Advantageously the water, if used in the buoyancy balloon as the buoyancy fluid, is available on the seabed and need not be transported to the seabed, as is the case with conventional lifting bodies. It is true that the use of a heated fluid hydrocarbon compound means that this must be transported in the buoyancy balloon to the seabed. However, in contrast to the conventional use of benzene for lifting purposes advantages ensue from an increased lifting force, and/or the option of using a buoyancy balloon with a reduced volume.

In accordance with a second aspect the invention is based on the general technical teaching of providing a balloon device that is configured for raising at least one object from the seabed, and comprises a buoyancy balloon with a balloon envelope (balloon skin), whose interior space can be filled with a buoyancy fluid, and a holding device, with which the at least one object can be coupled to the buoyancy balloon. In accordance with the invention the buoyancy balloon is adapted for the accommodation of the buoyancy fluid at a temperature that is elevated above the temperature of the seawater that surrounds the buoyancy balloon. In addition in accordance with the invention the balloon envelope has a low thermal conductivity such that the buoyancy fluid in the buoyancy balloon can be maintained at the elevated temperature. The thermal conductivity is selected such that the buoyancy fluid in the buoyancy balloon can be maintained at the elevated temperature for a time interval that is necessary for an uplift movement of the balloon device to the sea surface. The inventive balloon device is an underwater vehicle, which can be supported by the static lift of the heated buoyancy fluid in the buoyancy balloon. The buoyancy balloon is adapted for the accommodation of, e.g. water, or a fluid hydrocarbon compound, at the elevated temperature.

In accordance with the invention it is particularly preferable for water to be used as the buoyancy fluid. The term “water” denotes any fluid that contains chemically pure water and optionally any substances that are dissolved in it. The water can contain salt, in particular can be chemically identical with the seawater, or can comprise subterranean groundwater. Alternatively a fluid hydrocarbon compound is used as the buoyancy fluid. The term “fluid hydrocarbon compound” denotes any organic fluid that has a lower density than that of water in the deep sea, such as e.g. ethanol, benzene, light oils.

In order to raise the at least one object from the seabed the buoyancy balloon is typically provided directly on the seabed, whereby the buoyancy balloon is already filled, or will be filled, with the buoyancy fluid at an elevated temperature, and moved in the direction of the sea surface. However, the phrase “from the seabed” also includes a use of the invention in which the object to be raised is not located directly on the seabed, but, e.g. by virtue of the recovery technology that is being used, is positioned at a certain height, e.g. on a platform, above the seabed. In accordance with the invention the at least one object is raised (lifted) from the seabed in the direction towards the sea surface. The transportation process leads typically to the sea surface, where the at least one object is moved over into a ship. Alternatively the transportation process can lead to a position underneath the sea surface, e.g. to an undersea transporter, or to another position on the seabed.

The invention is suitable for the transportation of different types of objects, which in general comprise solid bodies. The at least one object preferably comprises a container, such as e.g. a net or a cage, with a multiplicity of raw material bodies, such as e.g. metallic nodules. The invention advantageously enables the transportation of selectively acquired metallic nodules, of the order of tons in mass, in an environmentally friendly manner, and, on occasion, even without the use of external energy sources, from deep sea to the surface, and their recovery by ships on the high seas. A further advantage is that this process can be repeated as often as required, and can be executed accurately with a minimum of additional components on the seabed. Both the fauna on the site and also the volumes of water located above the site are not affected by the transportation process at all, or only slightly, and are not contaminated.

The temperature of the buoyancy fluid can be selected in dependency on the particular conditions in the application of the invention, in particular the mass of the object that is being transported and the duration of the transportation process. Advantages ensue in the form of a high lifting force and the stable maintenance of the fluid state of the buoyancy fluid, in particular of the water in the buoyancy balloon, if the temperature of the buoyancy fluid in the buoyancy balloon at the start of the uplift movement is at least 80° C., in particular at least 100° C. and/or at most 350° C., in particular at most 300° C.

There exists the option of heating the buoyancy fluid on the seabed or in the buoyancy balloon to the desired temperature, e.g. with an electrical heating device. Particularly preferable is, however, an embodiment of the invention in which the buoyancy balloon is filled with a buoyancy fluid comprising water at an elevated temperature from a natural reservoir. Hot sources (“hot smokers”) are present in deep sea, from which the water exits at a temperature of up to 400° C. The said hot water is guided into the buoyancy balloon, if necessary by means of a guidance device, whereby the buoyancy balloon can unfold above, or in the vicinity of, the hot source. If such hot water sources are not available a hot water source can be artificially generated by means of deep drilling on the ocean bed using geothermal methods of known art. In this manner water is preferably guided out of an undersea source and/or an undersea borehole through the feed opening into the interior of the buoyancy balloon. These embodiments have the important advantage that water in natural reservoirs is already present at an elevated temperature, e.g. in the ranges cited above. The earth's geothermal heat can thus be utilized as a natural energy reservoir for the transportation process.

In particular for the filling of the buoyancy balloon on the seabed the balloon envelope preferably has a feed opening that can be closed, through which the buoyancy balloon can be filled with the buoyancy fluid. When using water the feed opening has a size such that the filling of the buoyancy balloon can be undertaken within a time interval that is negligibly small in comparison to the duration of any temperature equalization with the surrounding seawater. On the other hand when using a fluid hydrocarbon compound the feed opening can have a smaller size.

For the upward transportation the feed opening—other than is the case in a hot air balloon—is preferably closed, whereby this closure device does not have to be completely watertight. The closure device is configured such that no direct heat exchange takes place at the feed opening between the cold water of the surroundings (temperature e.g. −1 to +5° C.) and the hot buoyancy fluid. In accordance with a further advantageous embodiment of the invention provision is therefore made for the buoyancy balloon to be closed on all sides during the uplift movement. In particular the feed opening is blocked such that any exchange of fluid between the interior of the buoyancy balloon and the surroundings is prevented, or is negligibly small. An outflow of heat by means of convection is thereby advantageously prevented.

The balloon envelope preferably comprises a flexible and foldable material. This enables, in particular when water is being used as the buoyancy fluid, the buoyancy balloon to be transported in a folded state quickly and in an energy-efficient manner to the seabed. Alternatively or additionally the feed opening can comprise an opening directly in the balloon envelope. By this means the structure of the balloon device is advantageously simplified.

In contrast to a hot air balloon, the skin of which is embodied as lightly and thinly as possible, the thickness of the balloon envelope of the inventively used buoyancy balloon does not present a critical factor. Thus in accordance with a further advantageous form of embodiment of the invention the balloon envelope can comprise a layered composite material, optionally with structural elements such as ribs or stiffeners. The balloon envelope can e.g. comprise a plastic fabric composite material and/or foamed materials, which have advantages with regard to low thermal conductivity. The layered composite material can be formed from a plurality of layers with different functions in each case. One layer can, for example, be of a watertight material, while another layer can, for example, be of a thermally insulating material. Alternatively the balloon envelope can be manufactured from a single layer of a thermally insulating material.

The supporting capability of the balloon device depends on state variables of the buoyancy balloon, which comprise the temperature of the buoyancy fluid in the interior of the buoyancy balloon at the start of the uplift movement, the temperature of the seawater on the outer face of the buoyancy balloon at the start of the uplift movement, the volume of the buoyancy balloon, and the thermal conductivity of the balloon envelope.

The invention advantageously enables the supporting capability of the balloon device to be specifically prescribed by adjusting at least one of the state variables cited. In practical applications of the invention there exists in particular the possibility of selecting the volume of the buoyancy balloon and the thermal conductivity of the balloon envelope such that a sufficient supporting capability is achieved for the particular object that is to be raised. By virtue of the particular pressure and temperature conditions in deep sea and along the path ascending up to the sea surface, state variables of the buoyancy balloon can be adjusted such that the buoyancy fluid in the buoyancy balloon assumes different states during the uplift movement. In accordance with a first variant state variables, in particular the thermal conductivity of the balloon envelope, are selected such that during the uplift movement a proportion of the buoyancy fluid in the buoyancy balloon is converted into vapor, in particular water vapor. This conversion is achieved by using a balloon envelope with a low thermal conductivity (high insulation capability) such that the temperature of the buoyancy fluid in the buoyancy balloon with decreasing hydrostatic pressure of the surrounding seawater exceeds the boiling point. The vapor can advantageously be used to accelerate the uplift movement. For example, when using water as the buoyancy fluid a proportion of the water vapor can be driven out of the buoyancy balloon. Alternatively the buoyancy balloon in at least one section of the balloon envelope can also inflate such that its volume increases.

On the other hand there exists the possibility of selecting state variables of the buoyancy balloon, in particular the thermal conductivity of the balloon envelope, such that a formation of vapor is prevented. This variant of the invention is enabled by selecting the thermal conductivity of the balloon envelope such that the cooling of the buoyancy fluid in the buoyancy balloon on its path to the surface takes place such that the boiling point of the buoyancy fluid is never exceeded. In this variant of the invention the buoyancy fluid in the buoyancy balloon remains completely in the liquid state during the uplift movement.

The lifting force is directed in opposition to the gravitational force. The buoyancy balloon therefore moves inherently in a vertical direction towards the surface. Since, however, flows occur in the sea the buoyancy balloon could be driven off course during its uplift movement. In order to avoid this, in accordance with a further advantageous embodiment of the invention provision can be made for the buoyancy balloon to be connected to at least one object with a guidance device, which extends from the seabed to a predetermined position on the sea surface, e.g. a ship. The guidance device can e.g. comprise a cable, which is arranged between the seabed and the sea surface. It is not absolutely necessary for the cable to be oriented in a straight line. A curved form, e.g. as a function of the flows at various depths, is possible. In addition the guidance device can be adapted for purposes of guiding the balloon device in a sinking movement towards the seabed.

In accordance with a particularly preferred procedure, in particular when using water as the buoyancy fluid, the raising of the at least one object from the seabed takes place in accordance with the following steps.

Firstly there takes place a sinking movement of the balloon device, which is, for example, dropped from a ship into the sea. The flexible envelope of the buoyancy balloon is in the first instance empty and preferably folded up. Furthermore the balloon device is preferably equipped with a ballast body. The ballast body has advantages with regard to aiding the sinking movement into deep sea and the location of the buoyancy balloon on the seabed.

After reaching the seabed the buoyancy balloon is positioned such that the feed opening faces towards the seabed. The positioning advantageously takes place at a site at which the buoyancy balloon can be filled with water from a natural reservoir at an elevated temperature, and is oriented with the at least one object that is to be raised, such as e.g. a body of raw material, if necessary in a container.

The at least one object that is to be raised is coupled to the buoyancy balloon. The holding device of the balloon device preferably comprises cables that are slung around the buoyancy balloon. In the coupling process the at least one object is connected directly to the cables, or the container with the object is connected to the cables.

The buoyancy balloon is then filled with water, the temperature of which is higher than the temperature of the surrounding seawater. The buoyancy balloon inflates and assumes a shape corresponding to the form of the balloon envelope, e.g. a spherical shape. The buoyancy balloon thereby executes an initial raising movement. In this condition, the feed opening is preferably closed by using the cables for purposes of coupling to the at least one object.

The further raising movement of the buoyancy balloon together with the at least one object then takes place towards the sea surface. During the raising movement a gradual cooling of the water in the buoyancy balloon does indeed take place. As a result the velocity of the raising movement can reduce. However, with a suitable selection of the state variable at the start of the uplift movement the raising movement to the surface continues.

In accordance with a further advantageous embodiment of the invention the buoyancy balloon is provided with a valve device. It is particularly preferred if the valve device is connected to the balloon envelope so as to direct any residual gases or water vapor generated out from the interior of the buoyancy balloon to its surroundings.

In addition advantages for the positioning and orientation of the balloon device on the seabed can be achieved if the latter is equipped with a buoyancy body, with which the buoyancy balloon and its components, but without the at least one object, can be maintained in a floating state.

In addition the option exists of providing the balloon device with guiding bodies, which advantageously have a hydrodynamic action during the sinking movement of the balloon device. The guiding bodies enable the buoyancy balloon in the folded up state to be rendered taut during its sinking movement.

When the buoyancy balloon has been inflated the transportation containers together with the appropriate metal conglomerates are suspended in a suitable manner, and the anchorage of the buoyancy balloon to the seabed is released. The buoyancy balloon now raises with its load to the surface, where it can be recovered in its entirety by a ship, freed from its load, and can be delivered a second time, in a state in which it is folded up once again and fitted with a weight, into the depths of the sea.

In summary the invention is based in particular on the use of a thermally insulated buoyancy balloon that can support a load, which in deep sea is filled by means of hot sources, or boreholes installed at certain locations for purposes of extracting heated water, so that a volume of water is located in the buoyancy balloon with a significantly higher temperature compared with that of its surroundings. What is also important for the lifting force is the temperature difference in deep sea between the water inside the balloon envelope and its surroundings. For the ascent to the surface the time taken for the buoyancy balloon internal volume to cool, and the directed transportation to the surface and to the ship, are also of significance.

In the following, further details and advantages of the invention are described with reference to the accompanying figures, which show in:

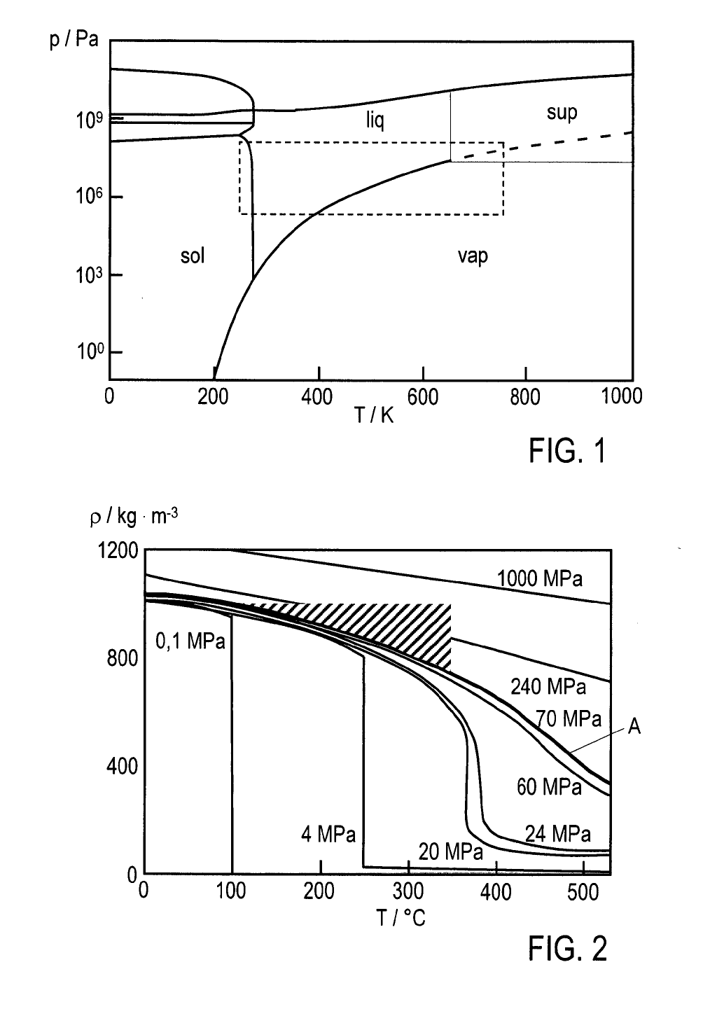

FIGS. 1 and 2: curves to illustrate the thermodynamic conditions in deep sea;

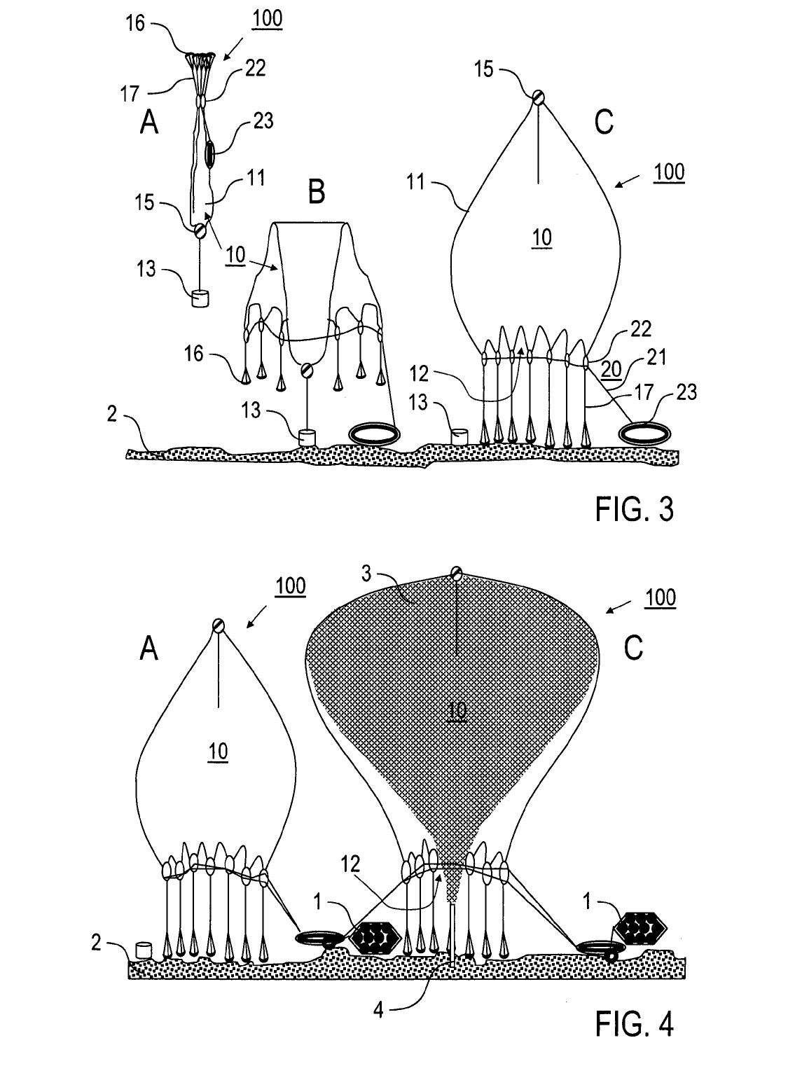

FIG. 3: a schematic illustration of the sinking movement and positioning of the inventive balloon device;

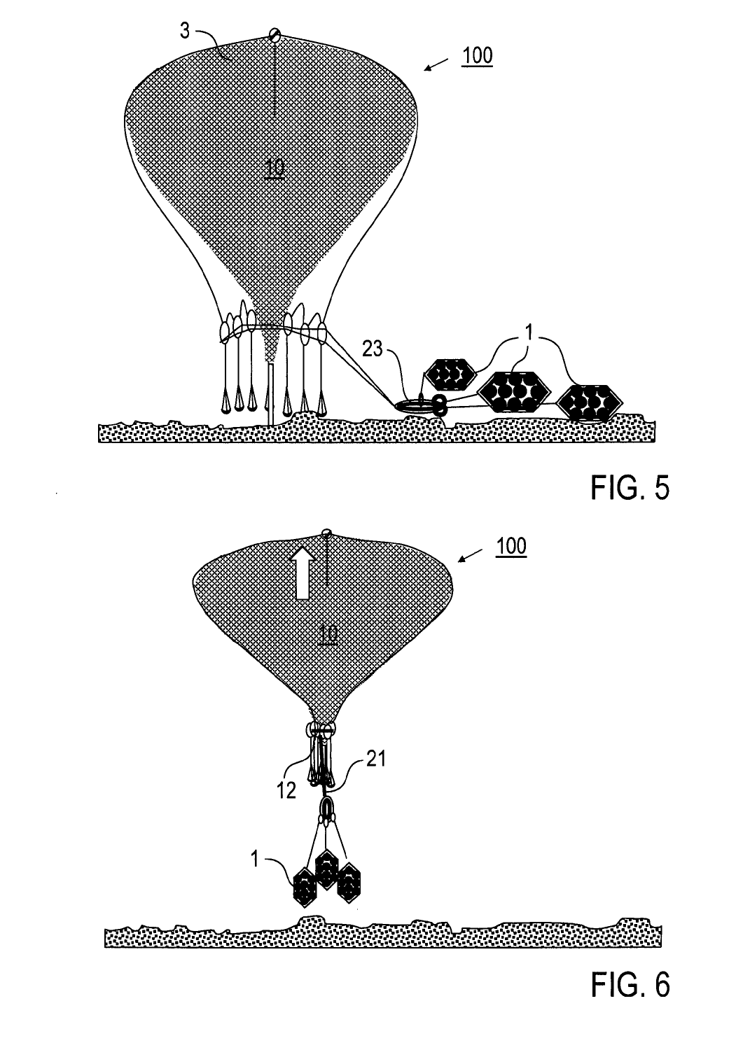

FIGS. 4 and 5: schematic illustrations of the filling and loading of the inventive balloon device;

FIGS. 6 to 8: schematic illustrations of the uplift movement of the inventive balloon device;

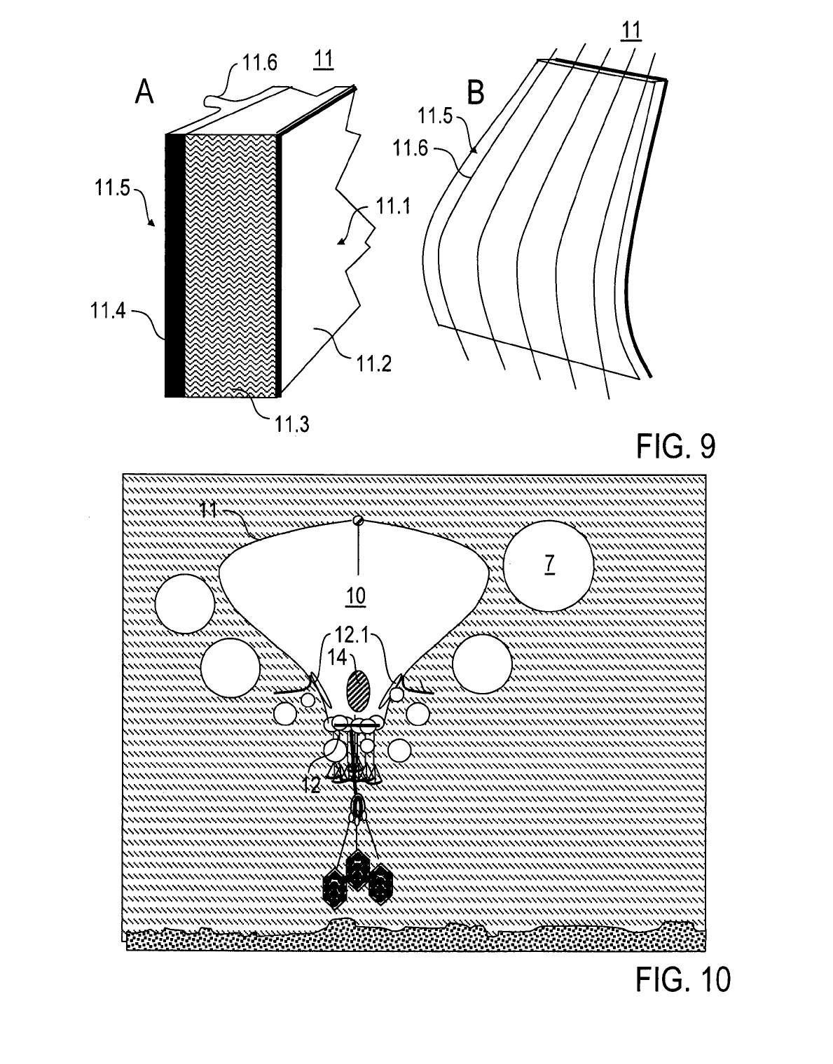

FIG. 9: schematic illustrations of preferred variants of the material of the balloon envelope of an inventively used buoyancy balloon;

FIG. 10: a schematic illustration of a further embodiment of the invention in which water vapor is released during the uplift movement; and

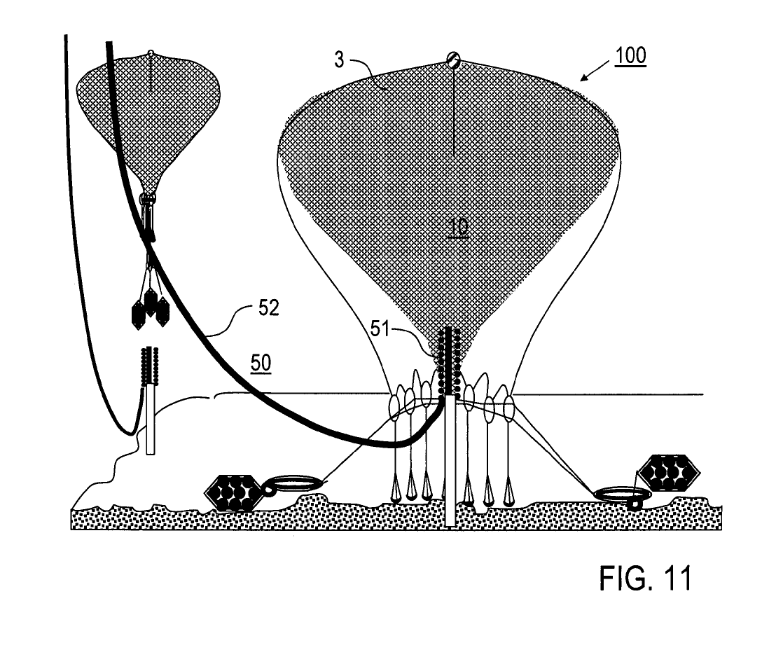

FIG. 11: a further embodiment of the invention in which the buoyancy fluid in the buoyancy balloon is electrically heated.

In the following, features of preferred embodiments of the invention are described in an exemplary manner with reference to a balloon device with a buoyancy balloon, which in the unfolded state has the external form of a body of rotation such as e.g. a sphere, or an ellipsoid, or a composite of these. The implementation of the invention in practice however is not limited to the forms shown, but is also possible with other forms of the buoyancy balloon with plane and/or curved surface sections, e.g. in the shape of a cuboid. In addition the buoyancy balloon, in a manner deviating from the examples shown with smooth surfaces for the balloon envelope, can alternatively have a structured surface. The surface of the balloon envelope can e.g. be corrugated by means of embedded structural elements.

Furthermore reference will be made in the following primarily to the particularly preferred embodiment of the invention in which water is used as the buoyancy fluid. Embodiments of the invention in which a fluid hydrocarbon is used as the buoyancy fluid can be implemented accordingly, whereby in these cases the buoyancy balloon has no feed opening of the kind represented in the figures, but rather a smaller feed opening equipped with a blocking element, and the fluid hydrocarbon is heated with an electrical heating device.

The particular configuration of the inventive balloon device, in particular the selection of the form and size of the buoyancy balloon and the geometry and composition of the balloon envelope can be selected by the person skilled in the art as a function of the particular application conditions, in particular the depth of sea from which the at least one object is to be recovered, the availability of natural hot water reservoirs, the flow conditions, and the mass of the object. Here the balloon is configured such that from the depth prescribed the mass prescribed can be transported with a sufficient velocity of uplift movement to the surface, so as to be recovered there by a ship. Here the person skilled in the art in particular can refer to the following thermodynamic considerations with reference to FIGS. 1 and 2, which are, for example, of known art from data on the Internet at www.lsbu.ac.uk/water/phase.html. Here FIG. 1 shows a pressure (p)—temperature (T) diagram for water. FIG. 1 shows the p-T conditions under which water is respectively in the solid (“sol”), vapor (“vap”), liquid (“liq”) or supercritical (“sup”) phases. In FIG. 1 the range of properties that occur in the ocean is framed with a dashed box. On the sea surface a pressure of 0.1 MPa exists, while the pressure at a depth of 10,000 m is somewhat more than 100 MPa. Water can exist at temperatures between −1° C. (open seawater) and +400° C. (from sources).

Furthermore FIG. 2 shows a density (p)—temperature (T) diagram for seawater at various pressure conditions. For seawater up to a depth of 7, 000 m the curves underneath the bold 70 MPa line (curve A) apply. The vertical lines of the curves for 0.1 MPa, 4 MPa, 20 MPa represent the transition to the gas phase. The density also reduces significantly at a depth of 2,000 m. Seawater with the salinity of the Pacific has a density of 1,050 kg/m³ at 0° C. With increasing temperature this also reduces at a depth of 7,000 m. At a depth of 7,000 m, water at a temperature of 300° C. has a density of 800 kg/m³, which is approximately 80% of the value at 0° C. The diagram illustrates the possibility of transporting significant loads to the surface by means of the buoyancy of heated seawater, as is presented in what follows.

Firstly it is shown that hot water in deep sea can be used to generate a lifting force. This ensues in the first instance from the fact that the density of water reduces with increasing temperature. Here the behavior of water in its volume-temperature dependency, not under isobaric conditions (0.1 MPa), but also as a function of pressure, is to be taken into account (V-T-P diagrams).

At a temperature higher than +374° C. and at a pressure greater than 221 bar, water undergoes a transition into a supercritical state (the “sup” region in FIG. 1). This means that there is no difference between the liquid and vapor states because the gas assumes the same density as that assumed by the liquid previously. FIG. 1 shows that the temperature range of natural hot sources in deep sea, according to our knowledge as of today, protrudes into the supercritical state region of the water. However, as a rule lower temperatures of between 100° C. and 300° C. occur in hot sources in deep sea. 400° C. is found in only a very few cases, so that one can assume from this that in the range of a 2 to 7 km depth of water that is relevant here, and at temperatures of less than 350° C., no supercritical conditions occur.

Furthermore it has been shown that even with increasing pressure an expansion of heated water is possible and the level of lift to which this leads. The density difference then allows an estimate to be made as to what transportation capability the invention offers.

In FIG. 2 the density p of the water (ordinate), and its temperature T (abscissa) are represented for various pressures in MPa (curves). If the deep sea region from a depth of 7 km up to the surface is considered the density of the water varies along a curve A (printed in bold), which is located closely above the curve for 60 MPa. If one limits oneself to temperatures less than +350° C., one sees that even in deep sea heated water still assumes a significantly higher volume than at a temperature of 0 to 20° C. Only at a pressure of more than 400 MPa would this no longer be the case, but this would correspond to unrealistic depths of 40 km. What is decisive for lift is thus the temperature difference relative to the surroundings. At a depth of, for example, 3,000 m and a 300° C. water temperature the density of the hot water is reduced by approximately 20%. The region that can be utilized for lift is marked out in FIG. 2 by the hatched triangle.

For a buoyancy balloon with a radius of 5 m used in accordance with the invention the following estimate ensues: The hot water volume is about 523 m³. With a 20 per cent reduction of the density (corresponding to a water temperature of less than +300° C.) a cold-water volume of approx. 105 m³ is displaced. In this manner a lift corresponding to the displaced water volume of the order of one- to two-digit number of tons ensues.

Since the pressure reduces during the ascent, the appropriate curves in FIG. 2 show that at pressures of 24 MPa and less a strong reduction in density can be registered. These vertically falling lines in FIG. 2 signify that the liquid water at this pressure suddenly undergoes a transition into the gaseous state and abruptly assumes a very large volume. If, for example, the temperature of the water in the buoyancy balloon is still more than 250° C., then at 4 MPa (that is to say, at a depth of 400 m) the water suddenly becomes gaseous and assumes 800 times the volume.

This effect can, on the one hand, be used to increase the lift of the system, but technical means are then required in order to blow off a proportion of the gas occurring. On the other hand, the possibility exists of preventing the formation of gas by means of the configuration of the buoyancy balloon skin. The latter is possible if the skin of the buoyancy balloon is not thermally insulated too well, but rather such that cooling on the path to the surface takes place to an extent in which the boiling point is never exceeded. Both variants are described below.

During the uplift movement the buoyancy balloon without guidance attempts to reach the surface vertically, whereby, however, it could drift as a result of flows and in the case of strong lift could wobble. When it arrives at the surface the buoyancy balloon continues to float on the surface where it can be detected (e.g. it can be visible by virtue of dyes, signals, etc.) until the lifting force, as a result of further cooling of the water in the buoyancy balloon, is matched by the weight of the buoyancy balloon with its load, and subsequently would become less than the latter, so that the buoyancy balloon with the freight would sink once again into deep sea. The time over which the system must maintain the heat in the interior volume so as to allow safe transportation of the freight to the surface and its safe recovery can be estimated as follows:

If one assumes a raising rate of the uplift movement of half a meter per second and assumes that one is located at a depth of 6,000 m then the surfacing process lasts for 12,000 seconds=200 minutes. If one now assumes that for purposes of recovering the buoyancy balloon at least 30 minutes needs to be available, a time of 230 minutes then ensues over which the interior of the buoyancy balloon must be maintained at a sufficiently high temperature such that a net buoyancy of the total system continues to be maintained up to the point of recovery.

The alternative variant to the free ascent consists in allowing the buoyancy balloon to raise upwards on a guidance cable, which establishes a link between the starting point on the seabed and the ship (see below, FIG. 8). The transportation downwards into deep sea can be undertaken on a second cable.

In FIG. 3 phases of the preparation of the inventive balloon device 100 for the execution of the transportation of a load from the seabed 2 up to the surface are schematically illustrated. The balloon device 100 comprises a buoyancy balloon 10 and a holding device 20, which are described below in further detail.

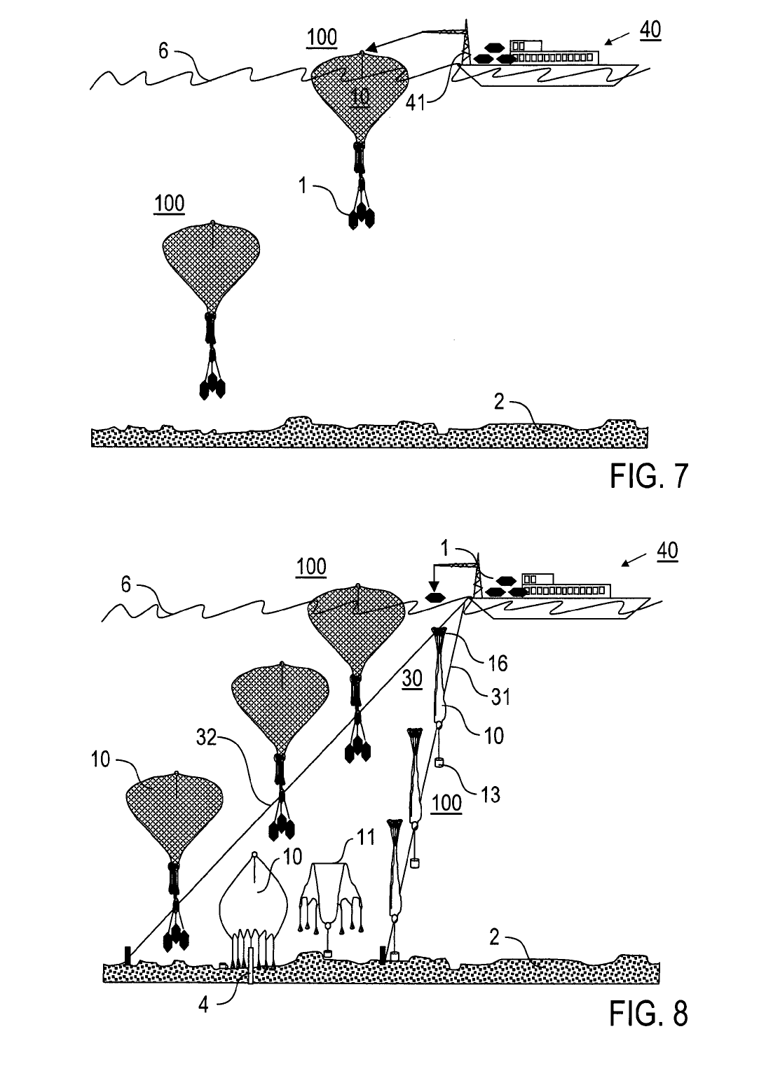

The balloon device 100 is firstly lowered from a ship (see also FIGS. 7 and 8) into the sea, whereby the buoyancy balloon 10 is to be found in a folded-up state. In FIG. 3A the sinking movement of the buoyancy balloon 10 in the folded-up state is schematically illustrated. The buoyancy balloon 10 is connected to a ballast body 13, a buoyancy body 15, and guiding bodies 16. The ballast body 13 is a towing weight, with a mass of e.g. 50 kg, which can be released from the buoyancy balloon 10; the mass and form of the ballast body 13 are selected such that during the sinking movement it is located at the forward end, i.e. in the gravitational direction (see arrow), at the lower end of the balloon device 100. The guiding bodies 16 are arranged at the opposite end of the balloon device 100.

The buoyancy body 15 has a mass density that is less than that of water. It comprises, for example, at least one pressure-resistant, hollow glass sphere, which is embedded in a resin. The buoyancy body 15 is dimensioned such that it can support the empty balloon envelope 11 of the buoyancy balloon. The ballast body 13 is connected via a cable to the buoyancy body 15.

The guiding bodies 16 possess a flat shape, e.g. a disc shape, as a result of which during the sinking movement the buoyancy balloon 10 is tautened in the rearward direction, i.e. in the upward direction. While the guiding bodies 16 are heavier than water, by virtue of their shape and attachment to cables 17 they form a flow resistance. The cables 17 are connected via holding rings 22 of the holding device to the buoyancy balloon 10. The holding rings 22 are arranged in a distributed manner along the edge of a feed opening 12 of the buoyancy balloon 10. Through the holding rings 22 runs a holding cable 21, to which the object that is to be raised can be coupled.

In addition the balloon device 100 can be equipped with a signaling device (not represented), which is adapted for communication, e.g. by means of acoustic and/or electromagnetic waves. The signaling device can, for example, output acoustic signals or light signals, which enable the location of the balloon device 100 during the sinking movement and/or on the seabed 2.

FIG. 3B shows the condition when the ballast body 13 reaches the seabed 2. The positioning of the buoyancy balloon 10 takes place such that the feed opening 12 in the balloon envelope 11 faces towards the seabed 2. This is achieved by virtue of the fact that the guiding bodies 16 are no longer pushed rearwards by the flow during the sinking movement, but instead sink towards the seabed 2. By this means the balloon envelope 11 is reversed (turned inside out). The outer face of the balloon envelope 11 during the sinking movement becomes the inner face of the balloon envelope 11 in the positioning of the balloon device 100 and the following steps. The balloon envelope 11 is pulled over the ballast body 13, while the guiding bodies 16 and a transportation ring 23, which is connected to the holding cable 21, sink onto the seabed 2.

The ballast body 13 is then separated from the buoyancy body 15. The separation can take place, for example, with a release mechanism controlled remotely, or automatically as a function of the tensile load on the cable between the ballast body 13 and the buoyancy body 15. As a result the buoyancy body 15, as shown in FIG. 3C, moves upwards, until the balloon envelope 11 is taut in the vertical direction, but in comparison to FIG. 3A has been reversed. The balloon envelope 11 is supported by the buoyancy body 15. Under the action of the guiding bodies 16 and the transportation ring 23 the balloon device 100 remains positioned on the seabed 2. As a result of the reversal of the balloon envelope 11 the guiding bodies 16 are arranged, spaced apart from one another, on a curved closed line, in particular an approximately circular line, so that the feed opening 12 on the face of the buoyancy balloon 10 facing towards the seabed 2 is stretched out.

FIG. 4 shows the coupling of the object 1 to the balloon device 100 and the filling of the buoyancy balloon 10 with hot water 3. FIG. 4A corresponds to the condition illustrated in FIG. 3C, whereby the object 1 is also shown. The object 1 comprises e.g. a container with manganese nodules, which is connected to the transportation ring 23. The container is, for example, suspended in the transportation ring 23. In a deviation from the illustration that shows a single object, a plurality of objects, e.g. a plurality of containers with manganese nodules, can alternatively be suspended in the transportation ring 23, or in other transportation rings (not shown).

After the coupling of the object 1 to the buoyancy balloon 10, hot water from an undersea source 4 is filled through the feed opening 12 into the interior of the buoyancy balloon 10. The filling process is shown schematically in FIG. 4B. Typically the positioning of the balloon device 100 after the sinking movement and reversal of the buoyancy balloon (FIG. 3) will not take place exactly over a source 4. However, the possibility exists of using a robotic system, operating autonomously on the seabed, so as to conduct the hot water 3 out of the source 4 through a connecting line into the buoyancy balloon 10.

While the hot water is being fed from the source 4 into the buoyancy balloon 10 the previous content of the latter, comprising cold seawater, is gradually dispersed into the surroundings and the balloon envelope is completely unfolded. As soon as an additional lifting force is generated by the hot water 3 in the balloon, the buoyancy balloon 10 executes an initial raising movement, so that the balloon envelope 11 and the holding cables 21 are under tension. Since the holding cable 21 runs through the holding rings 22 on the peripheral edge of the feed opening 12 the holding rings 22 are pulled together as a result of the tautening of the holding cable 21 and the feed opening 12 is closed. As a result of the weight of the object 1 the feed opening 12 is closed such that no material exchange, or only a negligible material exchange, takes place between the interior of the buoyancy balloon 10 and the surroundings.

The condition of the buoyancy balloon 10 shortly before liftoff is once again shown in FIG. 5, here with a plurality of objects 1 on the transportation ring 23. The buoyancy balloon 10 is filled with water 3 at a temperature in the range from e.g. 200° C. to 350° C., while the surrounding seawater has a temperature of about 0° C. Accordingly the water 3 has a lower density than the surrounding seawater, so that the desired lifting force is generated. After the initial raising movement of the balloon device 100 the additional objects 1 shown in FIG. 5 can be suspended in the transportation ring 23.

In FIGS. 6 and 7 are shown schematically the further phases of the uplift movement of the balloon device 100 with the buoyancy balloon 10 and its recovery by a ship 40 on the surface 6. It is stressed that the representation in FIG. 7 is not to scale. In the real deep sea conditions the extent of the balloon device 100 in the vertical direction (e.g. 5 m to 50 m) is much less than the sea depth of e.g. 4,000 m.

FIG. 6 shows the balloon device 100 with the suspended objects 1 at the moment of lift off. Under the action of the objects 1 the feed opening 12 is completely closed off by the holding cable 21, so that any cooling as a result of convection is prevented. The uplift movement takes place towards the sea surface, in the opposite sense to the direction of gravity (see arrow). When the balloon device 100 reaches the surface 6, in accordance with FIG. 7, it is the upper face of the buoyancy balloon 10 that is first visible. By means of markings (e.g. coloration) on the balloon envelope and/or acoustic and/or electromagnetic signals the balloon device 100 can be located by the ship 40. Using a grabbing device 41, such as e.g. a crane on board the ship 40, the balloon device 100 with the objects 1 can be taken on board.

FIG. 8 illustrates the repeated execution of the inventive method with one or a plurality of balloon devices 100 for purposes of recovering raw materials. Furthermore FIG. 8 shows a guidance device 30 with two guidance cables 31, 32, to which the balloon device 100 is coupled during the sinking movement and/or during the uplift movement. In detail, the balloon device 100 is firstly lowered from a ship 40 into the sea. As shown in FIG. 3A, the balloon device 100 executes a sinking movement, during which the buoyancy balloon 10 is folded up and is oriented under the action of the ballast body 13 and the guiding bodies 16. During the sinking movement the balloon device 100 is coupled, e.g. via a cable, to the first guidance cable 31. The first guidance cable 31 is held under tension between the ship 40 and a fixed position on the seabed 2. On arrival on the seabed 2 there takes place the above-described reversal of the balloon envelope and the positioning of the buoyancy balloon 10 over the source 4. For this purpose the balloon device 100 can be moved away from the lower anchorage point of the first guidance cable 31. To this end autonomous robotic systems or diving equipment, for example, are used on the seabed 2. After the filling of the buoyancy balloon 10 with water, the temperature of which is higher than that of the surrounding seawater, and the coupling of a plurality of objects 1 to the buoyancy balloon 10, the uplift movement towards the ship 40 takes place. For this purpose the balloon device 100 is coupled to the second guidance cable 32 of the guidance device 30. the second guidance cable 32 is held under tension between the ship 40 and another position. With the use of two guidance cables 31, 32, and the geometry as represented, the execution of an efficient cyclical process is simplified, in which, simultaneously with the sinking movement of one or a plurality of balloon devices 100, the uplift movement of one or a plurality of balloon devices 100 with suspended objects 1 can take place.

FIG. 9 shows further details of the construction of the balloon envelope 11. FIG. 9A illustrates a balloon envelope 11 in a cross-sectional representation in perspective. The balloon envelope 11 comprises a layered composite, which is constructed as follows. On the inner face 11.1 of the balloon envelope 11, which during the lifting phase of the balloon device faces towards the interior of the buoyancy balloon, and which is adjacent to the water at an elevated temperature, there is located firstly a heat-reflecting layer 11.2. This comprises e.g. an infrared radiation-reflecting metal foil, such as an aluminum foil. Adjacent to the latter is arranged a barrier layer 11.3, which has a lower thermal conductivity than the other layers of the balloon envelope 11. The barrier layer 11.3 comprises e.g. a plastic, such as e.g. a flat film made up from a copolymer of tetrafluorethylene and perfluorated co-components, or a flat film made up from a copolymer of tetrafluorethylene and hexafluorpropylene. Finally, an outer skin 11.4 is located on the barrier layer 11.3, which outer skin forms the outer face of the balloon envelope 11 in the state during the lifting phase of the buoyancy balloon. The outer skin 11.4 is manufactured from a durable material such as e.g. woven fabric, plastic netting, metal embedded in a seawater-resistant rubber coating, or polymer, and optionally is also fitted with reinforcing elements 11.6. The reinforcing elements 11.6 comprise e.g. ribs, which are integrated into the outer skin 11.4 and are schematically shown in the detail of the outer face 11.5 of the balloon envelope 11 in FIG. 9B.

The thickness and the material of the barrier layer 11.3 are typically selected such that during the uplift movement from the seabed 2 to the sea surface a defined lowering of temperature takes place and the formation of water vapor is avoided. Alternatively with sufficiently effective thermal insulation the method in accordance with the invention can be executed such that in the vicinity of the sea surface, or when surfacing, the water in the buoyancy balloon is still sufficiently hot that as a result of the reduction in pressure it undergoes a direct transition into the vapor state. This condition is schematically illustrated in FIG. 10. With the generation of the water vapor the density in the buoyancy balloon 10 reduces abruptly with, at the same time, a massive increase in volume. In order to prevent the balloon envelope 11 from bursting the feed opening 12 or other openings 12.1 of the buoyancy balloon 10 are pushed open so that water vapor 7 can escape from the buoyancy balloon 10. In the event that this is insufficient, a valve device 14 can be integrated into the balloon envelope 11, through which water vapor can escape into the surroundings as necessary.

The provision of the water 3 at an elevated temperature need not necessarily take place using a natural source. Instead an electrical heating device 50 can be provided for purposes of heating the water 3 in the buoyancy balloon 10. This embodiment of the invention is schematically illustrated in FIG. 11. The heating device 50 comprises an electrical resistance heating element 51, which is connected via a supply cable 52 to a power source, e.g. on a ship on the surface. Via the connecting line 52 electrical energy at a high power rating is introduced into the resistance-heating element 51, in order to heat the water 3 in the buoyancy balloon up to the desired temperature. The resistance heating element 51 projects, e.g. through the feed opening 12, into the buoyancy balloon 10. In the event that no feed opening is provided, e.g. if using a fluid hydrocarbon as the buoyancy fluid, the resistance heating element 51 is brought into thermal contact with the buoyancy fluid in the buoyancy balloon 10 by the deformation of a flexible section of the balloon envelope. After reaching the desired temperature the uplift movement towards the surface takes place as has been described above.

The invention has been described above with reference to the example of the recovery of raw materials. The application of the invention is not limited to the extraction of raw materials, but accordingly is also possible when transporting other loads, such as e.g. from wreckage.

The features of the invention disclosed in the above description, the drawings, and the claims, can be of importance, both individually and also in any combination for the implementation of the invention in its various configurations.

1. A method for raising an object from a seabed, comprising the steps:
coupling of the object to a buoyancy balloon, and
uplift movement of the buoyancy balloon with the object,
wherein—the buoyancy balloon is filled with a buoyancy fluid, which is at an elevated temperature above a temperature of seawater that surrounds the buoyancy balloon.

2. The method in accordance with claim 1, in which:
at a start of the uplift movement of the buoyancy balloon with the object, the elevated temperature of the buoyancy fluid in the buoyancy balloon is from 80°C. to 350° C.

3. The method in accordance with claim 1, in which:
the buoyancy fluid comprises water or a fluid hydrocarbon compound.

4. The method in accordance with claim 1, in which:
the buoyancy fluid the buoyancy balloon on the seabed is heated with an electrical heating device.

5. The method in accordance with claim 1, in which:
the buoyancy balloon is filled with water from at least one of an undersea source and an undersea borehole.

6. The method in accordance with claim 1, in which:
during the uplift movement the buoyancy balloon is closed on all sides.

7. The method in accordance with claim 1, in which:
state variables of the buoyancy balloon are adjusted such that during the uplift movement the buoyancy fluid in the buoyancy balloon is partially converted into a vapor.

8. The method in accordance with claim 7, including at least one of the features:
the vapor is used for accelerating the uplift movement, and
the vapor is at least partially dispersed into the surrounding seawater.

9. The method in accordance with claim 1, in which:
state variables of the buoyancy balloon are adjusted such that during the uplift movement the buoyancy fluid the buoyancy balloon remains in a fluid state.

10. The method in accordance with claim 7, in which:
the adjusted state variables of the buoyancy balloon comprise at least one of: the elevated temperature of the buoyancy fluid at a start of the uplift movement, a volume of the buoyancy balloon, and a thermal conductivity of a balloon envelope of the buoyancy balloon.

11. The method in accordance with claim 1, in which:
during the uplift movement the buoyancy balloon with the object is connected to a guidance device, which extends from the seabed to a ship.

12. The method in accordance with claim 1, in which:
the object comprises a multiplicity of geological bodies with a metallic content.

13. The method in accordance with claim 1, further comprising the following steps:
sinking movement of the buoyancy balloon in a folded-up state under action of a ballast body to the seabed,
positioning of the buoyancy balloon on the seabed such that a feed opening of the buoyancy balloon faces towards the seabed,
coupling of the object to the buoyancy balloon,
feeding of the buoyancy fluid at the elevated temperature into the buoyancy balloon, such that the buoyancy balloon executes an initial raising movement,
closure of the feed opening under action of a weight of the object, and
further raising movement of the buoyancy balloon.

14. A balloon assembly, which is configured for raising an object from a seabed, comprising:
a buoyancy balloon with a balloon envelope, the interior of which can be filled with a buoyancy fluid, and
a holding device, with which the object can be coupled to the buoyancy balloon, wherein
the buoyancy balloon is adapted for accommodating the buoyancy fluid at an elevated temperature that is elevated above a temperature of the seawater that surrounds the buoyancy balloon, and
the balloon envelope has such a low thermal conductivity that the buoyancy fluid in the buoyancy balloon can be maintained at the elevated temperature.

15. The balloon assembly in accordance with claim 14, in which:
the balloon envelope comprises a closable feed opening, through which the buoyancy balloon can be filled with the buoyancy fluid.

16. The balloon assembly in accordance with claim 14, in which:
the balloon envelope is manufactured from a flexible, foldable material, and/or
the feed opening comprises an opening in the balloon envelope.

17. The balloon assembly in accordance with claim 14, in which:
the balloon envelope comprises a layered composite material.

18. The balloon assembly in accordance with claim 14, in which:
the balloon envelope comprises a material, a thermal conductivity of which is selected such that during an uplift movement the buoyancy fluid in the buoyancy balloon is partially converted into vapor.

19. The balloon assembly in accordance with claim 18, in which:
the balloon envelope comprises a valve device, with which vapor can be conducted away from the interior into surroundings of the buoyancy balloon.

20. The balloon assembly in accordance with claim 14, in which:
the balloon envelope comprises a material, a thermal conductivity of which is selected such that during an uplift movement the buoyancy fluid in the buoyancy balloon remains in a fluid state.

21. The balloon assembly in accordance with claim 14, in which:
the holding device comprises at least one holding cable.

22. The balloon assembly in accordance with claim 14, which further comprises at least one of:
a ballast body, under action of which the buoyancy balloon in a folded-up state can execute a sinking movement, and can be held on the seabed,
a buoyancy body, under action of which the buoyancy balloon can be maintained in a floating state, and
a multiplicity of guiding bodies, under action of which the buoyancy balloon in a folded-up state can be held taut during a sinking movement.

23. The method in accordance with claim 7, wherein the buoyancy fluid is partially converted into water vapor.
